(19) United States
(12) Patent Application Publication
(10) Pub. No.: US 2025/0070583 A1
(43) Pub. Date: Feb. 27, 2025

(54) BATTERY CHARGING METHOD, BATTERY CHARGING DEVICE, AND BATTERY CHARGING APPARATUS

(71) Applicant: ZHEJIANG JINKO ENERGY STORAGE CO., LTD., Haining (CN)

(72) Inventors: Zixiang YANG, Haining (CN); Xiangming WANG, Haining (CN); Yuhao WU, Haining (CN)

(21) Appl. No.: 18/945,862

(22) Filed: Nov. 13, 2024

(30) Foreign Application Priority Data
Oct. 28, 2024 (CN) 202411513756.6

(51) Int. Cl. H02J 7/00; H01M 10/44

(52) U.S. Cl. CPC H02J 7/00712; H01M 10/44; H02J 7/0047

(57) ABSTRACT

Disclosed are a battery charging method, a battery charging device, and a battery charging apparatus. The battery charging method, comprising: determining a direct current resistance (DCR) curve of a rechargeable battery in response to a charging instruction for the rechargeable battery; obtaining a real-time impedance of the rechargeable battery, and determining an impedance interval in the DCR curve corresponding to the real-time impedance; and determining a current charging strategy for the rechargeable battery according to the impedance interval corresponding to the real-time impedance, and charging the rechargeable battery by using the current charging strategy.

### CROSS-REFERENCE TO RELATED APPLICATION

The present application claims the priority of Chinese patent application No. 202411513756.6, filed on Oct. 28, 2024, and entitled “BATTERY CHARGING METHOD, CHARGING DEVICE, AND CHARGING APPARATUS”, which is incorporated herein by reference in its entirety.

### TECHNICAL FIELD

The present application relates to the field of battery technology, and in particular to a battery charging method, a battery charging device, and a battery charging apparatus.

### BACKGROUND

Battery fast charging technology is for increasing a charging rate, which may input more electrical energy into the battery in a same time duration, thereby speeding up the charging process and achieving a fast charging.

### SUMMARY

The present disclosure provides a battery charging method, a battery charging device, and a battery charging apparatus.

In a first aspect, the present disclosure provides a battery charging method, including: determining a direct current resistance (DCR) curve of a rechargeable battery in response to a charging instruction for the rechargeable battery, obtaining a real-time impedance of the rechargeable battery, and determining an impedance interval in the DCR curve corresponding to the real-time impedance, and determining a current charging strategy for the rechargeable battery according to the impedance interval corresponding to the real-time impedance, and charging the rechargeable battery by using the current charging strategy, wherein determining the current charging strategy for the rechargeable battery according to the impedance interval corresponding to the real-time impedance comprises: determining the current charging strategy to be a first charging strategy having a charging rate ranging from −0.2C to 0.2C, in response to the real-time impedance of the rechargeable battery corresponding to a high-impedance interval, and determining the current charging strategy to be a second charging strategy with a charging rate ranging from 0.5C to 5C, in response to the real-time impedance of the rechargeable battery corresponding to a low-impedance interval.

In an embodiment, determining the impedance interval in the DCR curve corresponding to the real-time impedance comprises: obtaining the maximum impedance value of the DCR curve, and determining the impedance interval in the DCR curve corresponding to the real-time impedance according to the maximum impedance value and the real-time impedance.

In an embodiment, determining the impedance interval in the DCR curve corresponding to the real-time impedance according to the maximum impedance value and the real-time impedance comprises: determining the real-time impedance to belong to the high-impedance interval, in response to the real-time impedance being greater than 60% of the maximum impedance value, determining the real-time impedance to belong to the low-impedance interval, in response to the real-time impedance being less than 60% of the maximum impedance value, and determining the real-time impedance to belong to the high-impedance interval or the low-impedance interval, in response to the real-time impedance being equal to 60% of the maximum impedance value.

In an embodiment, determining the DCR curve of the rechargeable battery comprises: obtaining a current number of charge cycles of the rechargeable battery, obtaining a mapping relationship between numbers of charge cycles and DCR curves, and obtaining the DCR curve matching the current number of charge cycles of the rechargeable battery based on the current number of charge cycles and the mapping relationship between the numbers of charge cycles and the DCR curves.

In an embodiment, obtaining the mapping relationship between the numbers of charge cycles and the DCR curves comprises: obtaining DCR curves of a reference battery going through different numbers of charge cycles, each of the DCR curves of the reference battery comprising a corresponding relationship between states of charge (SOCs) and impedance values of the reference battery when the reference battery is charged from an empty state to a fully charged state; and constructing the mapping relationship between the numbers of charge cycles and the DCR curves according to the DCR curves of the reference battery going through the different numbers of charge cycles.

In an embodiment, obtaining the DCR curves of the reference battery going through the different numbers of charge cycles comprises: determining a plurality of different preset numbers of charge cycles, each of the plurality of different preset numbers of charge cycles is counted from an initial charging of the reference battery; obtaining an initial voltage curve of the reference battery during the initial charging; discharging and charging the reference battery cyclically, discharging the reference battery to an empty state, and charging the reference battery from the empty state to a fully charged state by using a preset current, until the number of charge cycles of the reference battery reaches each of the plurality of different preset numbers of charge cycles, and obtaining a first voltage curve of the reference battery at each of the plurality of different preset numbers of charge cycles, and obtaining a plurality of first voltage curves corresponding to the different preset numbers of charge cycles; and determining a plurality of impedance values corresponding to a plurality of SOCs in each of the plurality of first voltage curves, and fitting a correspondence relationship between the plurality of SOCs and the plurality of impedance values to obtain a DCR curve corresponding to each of the plurality of different preset numbers of charge cycles, and obtaining a plurality of DCR curves corresponding to the different preset numbers of charge cycles.

In an embodiment, each of the plurality of impedance values corresponding to each of the plurality of SOCs of each of the plurality of first voltage curves is calculated according to an equation:

$${Rs}_{{SOC}_{X}} ( {V}_{1 x} - {V}_{nX} ) / I$$

Where, n denotes a preset number of charge cycles; SOC_{X} denotes a state of charge; Rn_{soc}_{_{X}} denotes an impedance value corresponding to the state of charge SOC_{X} at the preset number of charge cycles n; V_{1X} denotes a voltage value in the initial voltage curve corresponding to the state of charge SOC_{X}; V_{nX} denotes a voltage value corresponding to the state of charge SOC_{X} at the preset number of charge cycles n; and I denotes a preset current.

In an embodiment, obtaining the first voltage curve of the reference battery at each of the plurality of different preset numbers of charge cycles comprises: during each of the plurality of different preset numbers of charge cycles, charging the reference battery with a rated current, and collecting a plurality of voltage values of the reference battery at an interval of a set time, and obtaining a plurality of SOCs corresponding to the plurality of voltage values of the reference battery; and fitting the plurality of voltage values and the plurality of SOCs corresponding to the plurality of voltage values to obtain the first voltage curve of the reference battery at each of the plurality of different preset numbers of charge cycles.

In an embodiment, each of the plurality of SOCs corresponding to the plurality of voltage values of the reference battery is calculated according to an equation:

$${SOC}_{X} = {SOC}_{1} + ( {SOC}_{2} - {SOC}_{1} ) \times \frac{{C}_{X}}{{C}_{1}}$$

Where SOC_{X} denotes a state of charge, SOC₁ denotes a state of charge of the reference battery in the empty state at a preset number of charge cycles, SOC₂ denotes a state of charge of the reference battery in the fully charged state at the preset number of charge cycles, C_{X} denotes a charge capacity of the reference battery during a charging process corresponding to the state of charge SOC_{X} at the preset number of charge cycles, and C₁ denotes a charge capacity in the initial voltage curve corresponding to the state of charge SOC_{X}.

In an embodiment, determining the DCR curve of the rechargeable battery comprises: determining a cathode material of the rechargeable battery; obtaining a mapping relationship between cathode materials and DCR curves; and obtaining the DCR curve matching the rechargeable battery based on the cathode material of the rechargeable battery and the mapping relationship between the cathode materials and the DCR curves.

In an embodiment, obtaining the real-time impedance of the rechargeable battery comprises: obtaining a real-time charging voltage and a real-time SOC of the rechargeable battery in real time; and obtaining the real-time impedance based on the real-time charging voltage and the real-time state of charge.

In an embodiment, the first charging strategy is implemented by alternately executing a first charging stage and a first depolarizing stage; and the first charging strategy comprises a charging rate and a charging duration of the first charging stage, and a depolarizing rate and a depolarizing duration of the first depolarizing stage.

The charging duration of the first charging stage is determined according to a change trend of the DCR curve, and when the DCR curve changes with a rising trend, the charging duration of the first charging stage decreases, and when the DCR curve changes with a declining trend, the charging duration of the first charging stage increases.

The depolarizing duration of the first depolarizing stage is determined according to the change trend of the DCR curve, and when the DCR curve changes with a rising trend, the depolarizing duration of the first depolarizing stage increases, and when the DCR curve changes with a declining trend, the depolarizing duration of the first depolarizing stage decreases.

In an embodiment, the charging rate of the first charging stage is determined according to the change trend of the DCR curve, and when the DCR curve changes with the rising trend, the charging rate of the first charging stage decreases, and when the DCR curve changes with the declining trend, the charging rate of the first charging stage increases; and the charging rate of the first charging stage ranges from 0C to 0.2C.

The depolarizing rate of the first depolarizing stage is determined according to the change trend of the DCR curve, and when the DCR curve changes with the rising trend, the depolarizing rate of the first depolarizing stage decreases, and when the DCR curve changes with the declining trend, the depolarizing rate of the first depolarizing stage increases; and the depolarizing rate of the first depolarizing stage ranges from −0.2C to 0C.

In an embodiment, the second charging strategy is implemented by alternately executing a second charging stage and a second depolarizing stage, and the second charging strategy comprises a charging rate and a charging duration of the second charging stage, and a depolarizing rate and a depolarizing duration of the second depolarizing stage.

The charging duration of the second charging stage is determined according to a change trend of the DCR curve, and when the DCR curve changes with a rising trend, the charging duration of the second charging stage decreases, and when the DCR curve changes with a declining trend, the charging duration of the second charging stage increases.

The depolarizing duration of the second depolarizing stage is determined according to the change trend of the DCR curve, and when the DCR curve changes with a rising trend, the depolarizing duration of the second depolarizing stage increases, and when the DCR curve changes with a declining trend, the depolarizing duration of the second depolarizing stage decreases.

In an embodiment, the charging rate of the second charging stage is determined according to the change trend of the DCR curve, and when the DCR curve changes with the rise trend, the charging rate of the second charging stage decreases, and when the DCR curve changes with the declining trend, the charging rate of the second charging stage increases; and the charging rate of the second charging stage ranges from 2.5C to 5C.

The depolarizing rate of the second depolarizing stage is determined according to the change trend of the DCR curve, and when the DCR curve changes with the rising trend, the depolarizing rate of the second depolarizing stage decreases, and when the DCR curve changes with the declining trend, the depolarizing rate of the second depolarizing stage increases; and the depolarizing rate of the second depolarizing stage ranges from −0.2 to 2C.

In an embodiment, determining the impedance interval in the DCR curve corresponding to the real-time impedance comprises: obtaining an average impedance value of the DCR curve, and determining the impedance interval in the DCR curve corresponding to the real-time impedance as a high-impedance interval in response to the real time impedance is greater than the average impedance value; determining the impedance interval in the DCR curve corresponding to the real-time impedance as a low-impedance interval in response to the real time impedance is less than the average impedance value; and determining the impedance interval in the DCR curve corresponding to the real-time impedance as the high-impedance interval or the low-impedance interval in response to the real time impedance is equal to the average impedance value.

In an embodiment, fitting the correspondence relationship between the plurality of SOCs and the plurality of impedance values comprises fitting the correspondence relationship between the plurality of SOCs and the plurality of impedance values by any one of a linear regression, a polynomial fitting, and a nonlinear fitting.

In an embodiment, the set time is 0.1 s or 0.2 s.

In an embodiment, obtaining the mapping relationship between the cathode materials and the DCR curves comprises obtaining the mapping relationship between the cathode materials and the DCR curves through experimental data or empirical formulas, wherein the mapping relationship between the cathode materials and the DCR curves is stored in a mapping relationship table or in a database.

In a second aspect, the present disclosure provides a battery charging device, including a determination module, a monitoring module, and a charging module.

The determination module is configured to, in response to a charging instruction for a rechargeable battery, determine a DCR curve of the rechargeable battery.

The monitoring module is configured to obtain a real-time impedance of the rechargeable battery, and determine an impedance interval in the DCR curve corresponding to the real-time impedance.

The charging module is configured to determine a current charging strategy for the rechargeable battery according to the impedance interval corresponding to the real-time impedance, and charge the rechargeable battery by using the current charging strategy. In response to the real-time impedance of the rechargeable battery corresponding to a high-impedance interval, the current charging strategy is determined to be a first charging strategy having a charging rate ranging from −0.2C to 0.2C, and in response to the real-time impedance of the rechargeable battery corresponding to a low-impedance interval, the current charging strategy is determined to be a second charging strategy having a charging rate ranging from 0.5C to 5C.

In a third aspect, the present disclosure provides a battery charging apparatus, comprising a power supply device and a controller.

The power supply device is configured to charge a rechargeable battery.

The controller comprises at least one processor and a memory communicatively connected to the at least one processor. The memory has a computer program stored thereon, and the computer program is executable by the at least one processor, and the computer program, when executed by the at least one processor, enables the at least one processor to perform the battery charging method in the one aspect.

The battery charging method, the battery charging device, and the battery charging apparatus disclosed in the present disclosure aim to solve the problem of the lithium deposition or the excessive temperature rise in the battery caused when the existing battery is continuously charged at a high rate. The present invention determines a direct current resistance (DCR) curve of a rechargeable battery based on a charging instruction, obtains a real-time impedance of the rechargeable battery, determines an impedance interval in the DCR curve corresponding to the real-time impedance, determines a current charging strategy for the rechargeable battery according to the impedance interval corresponding to the real-time impedance, and charges the rechargeable battery based on the current charging strategy. When the impedance interval corresponding to the real-time impedance of the rechargeable battery changes, the current charging strategy is adjusted in real time, and the rechargeable battery is charged by using the current charging strategy adjusted in real time. Thus, the charging strategy can be adjusted in real time according to the real-time impedance of the rechargeable battery, thereby improving the charging efficiency of the rechargeable battery, reducing the problem of the lithium deposition or the excessive temperature rise in the battery caused when the battery is continuously charged at a high rate, and thus improving the charging reliability of the battery.

In addition, in the solutions of the application, the current charging strategy is determined based on the impedance interval of the DCR curve corresponding to the real-time impedance of the rechargeable battery. When the real-time impedance of the rechargeable battery belongs to the high-impedance interval, the current charging strategy is the first charging strategy having a lower charging rate. When the real-time impedance of the rechargeable battery belongs to the low-impedance interval, the current charging strategy is the second charging strategy having a higher charging rate. Thus, a suitable charging strategy can be selected according to the real-time impedance of the rechargeable battery, thereby improving the charging efficiency of the rechargeable battery, and reducing the risk of the lithium deposition or the excessive temperature rise in the battery caused when the battery is continuously charged at a high rate, and ensuring that the rechargeable battery maintains a good charging state during the charging process.

### BRIEF DESCRIPTION OF THE DRAWINGS

In order to illustrate the technical solutions of the embodiments of the present disclosure and the prior art more clearly, the drawings needed for the description of the embodiments and the prior art are briefly described hereinafter. Obviously, the drawings described hereinafter are only some embodiments of the present disclosure. For the ordinary skilled in the art, other drawings may be obtained based on these drawings without creative work.

FIG. 1 is a schematic flow chart of a battery charging method according to an embodiment.

FIG. 2 is a schematic view showing an initial voltage curve and a first voltage curve corresponding to a preset number of charge cycles according to an embodiment.

FIG. 3 is a schematic view showing a direct current resistance (DCR) curve of a ternary lithium according to an embodiment.

FIG. 4 is a schematic view showing a second charging strategy according to an embodiment.

FIG. 5 is a schematic view showing a DCR curve of a lithium iron manganese phosphate battery according to an embodiment.

FIG. 6 is a block diagram of a battery charging device according to an embodiment.

FIG. 7 is a block diagram of a battery charging apparatus according to an embodiment.

FIG. 8 is a block diagram of a controller according to an embodiment.

### DETAILED DESCRIPTION OF THE EMBODIMENTS

To facilitate understanding of the present disclosure, the present disclosure will be described in more detail hereinafter with reference to the relevant drawings. The preferred embodiments of the present disclosure are shown in the drawings. However, the present disclosure may be implemented in many different forms and is not limited to these embodiments described herein. On the contrary, the purpose of providing these embodiments is to make the contents of the present disclosure more thorough and comprehensive.

Unless otherwise defined, all technical and scientific terms used herein have the same meaning as those generally understood by the ordinary skilled in the art of the present disclosure. The terms used in the specification of the present disclosure herein are only for the purpose of describing specific embodiments and are not intended to limit the present disclosure.

In the related art, during a charging process of a battery, a continuous high charging rate may cause a lithium deposition or an excessive temperature rise in the battery. The charging rate refers to the speed at which the battery is charged or discharged, specifically a ratio of a charging or discharging current to a rated capacity of the battery. For example, for a 1000 mAh battery, charging at a rate of 1C means that a charging current is 1000 mA, and charging at a rate of 2C means that a charging current is 2000 mA, and so on.

Moreover, during the fast charging process of the battery, the greater the charging rate is, the greater the polarization of the battery is. The polarization may cause the negative electrode potential of the battery to drop rapidly, and when charging at a high rate, a higher voltage is required to overcome an additional overpotential, which means that during the charging process, more energy is consumed in overcoming the polarization, thus the efficiency of high-rated charging is reduced. In addition, a long-term polarization will accelerate the degradation of battery materials, such as changes in the structure of electrode materials, decomposition of electrolytes, etc., which will lead to a gradual decrease in the battery capacity and shorten a cycle life of the battery.

The battery charging method provided in the embodiments of the present application may be applied to an application environment of charging the battery. The method may be applied to a terminal, or a server, or may further be applied to a system including a terminal and a server and implemented through an interaction between the terminal and the server. The terminal may be, but is not limited to, any one of various personal computers, laptops, etc. For the problem of the lithium deposition or the excessive temperature rise in the battery caused when the existing battery is continuously charged at a high rate, the terminal determines a direct current resistance (DCR) curve of a rechargeable battery based on a charging instruction, obtains a real-time impedance of the rechargeable battery, determines an impedance interval in the DCR curve corresponding to the real-time impedance, determines a current charging strategy for the rechargeable battery according to the impedance interval corresponding to the real-time impedance, and charges the rechargeable battery based on the current charging strategy. When the impedance interval corresponding to the real-time impedance of the rechargeable battery changes, the terminal adjusts the current charging strategy in real time, and the rechargeable battery is charged by using the current charging strategy adjusted in real time. Thus, the charging strategy can be adjusted in real time according to the real-time impedance of the rechargeable battery, thereby improving the charging efficiency of the rechargeable battery, reducing the problem of the lithium deposition or the excessive temperature rise in the battery caused when the battery is continuously charged at a high rate, and thus improving the charging reliability of the battery. In addition, in the solutions of the application, the current charging strategy is determined based on the impedance interval of the DCR curve corresponding to the real-time impedance of the rechargeable battery. When the real-time impedance of the rechargeable battery belongs to the high-impedance interval, the current charging strategy is the first charging strategy having a lower charging rate. When the real-time impedance of the rechargeable battery belongs to the low-impedance interval, the current charging strategy is the second charging strategy having a higher charging rate. Thus a suitable charging strategy can be selected according to the real-time impedance of the rechargeable battery, thereby improving the charging efficiency of the rechargeable battery, reducing the risk of the lithium deposition or the excessive temperature rise in the battery caused when the battery is continuously charged at a high rate, and ensuring that the rechargeable battery maintains a good charging state during the charging process.

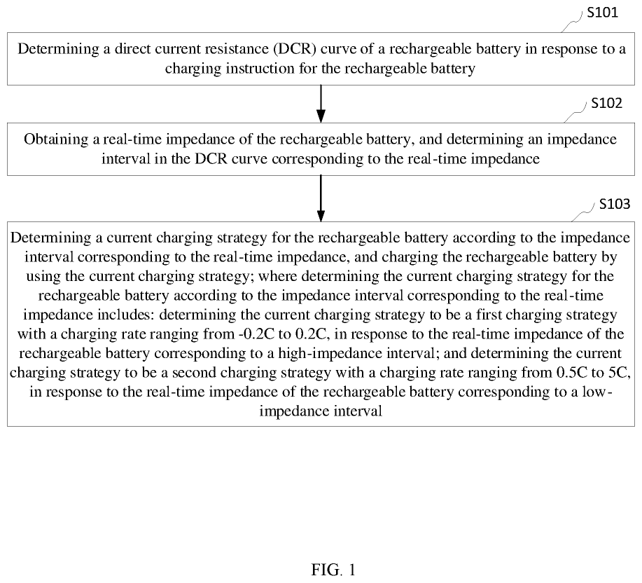

In an exemplary embodiment, as shown in FIG. 1, a battery charging method is provided, and the method is described by taking the method applied to a terminal as an example. The method includes the following steps S101 to S104.

In step S101, in response to a charging instruction for a rechargeable battery, a DCR curve of the rechargeable battery is determined.

In this embodiment, the terminal determines the DCR curve of the rechargeable battery in response to the charging instruction for the rechargeable battery.

The charging instruction for the rechargeable battery is an instruction to instruct the terminal to start a charging power supply to charge the rechargeable battery. The charging instruction for the rechargeable battery received by the terminal may be the charging interface of the rechargeable battery being plugged into the charging power supply. The charging power supply may include but is not limited to a charging pile, or a shared power supply, etc. Alternatively, the charging instruction may be starting charging by swiping a card or scanning a code, and the terminal detects whether the charging pile has received the charging instruction instructed by means of swiping the card or the charging instruction instructed by means of scanning the code, so as to start charging the rechargeable battery. For example, a user instructs to charge the rechargeable battery through an operation of swiping a card. Alternatively, the charging instruction may be a user's scanning a code through an application in a mobile phone, and the starting charging is selected through an operation interface of the application, so as to start charging the rechargeable battery.

In this embodiment, the terminal obtains the battery information of the rechargeable battery, and determines a corresponding DCR curve according to the battery information of the rechargeable battery. The battery information of the rechargeable battery may include, but is not limited to, a current state of charge (SOC) of the rechargeable battery, the number of charge cycles, and a cathode material. The specific process of determining the DCR curve of the rechargeable battery will be described in detail hereinafter.

In step S102, a real-time impedance of the rechargeable battery is obtained, and an impedance interval in the DCR curve corresponding to the real-time impedance is determined.

In this embodiment, the terminal obtains the DCR curve of the rechargeable battery based on the battery information (including the current SOC, the number of charge cycles, and the cathode material, etc.) of the rechargeable battery, and during the charging process of the rechargeable battery, the terminal detects the real-time impedance of the rechargeable battery in real time, and determines the impedance interval corresponding to the rechargeable battery in the DCR curve based on the real-time impedance of the rechargeable battery.

Specifically, the terminal may search a database or a mapping relationship table, and query DCR curves corresponding to the battery information of the rechargeable battery, to obtain a DCR curve matching the rechargeable battery. Then the terminal uses the DCR curve matching the rechargeable battery as a reference curve in the charging process of the rechargeable battery, and determines the impedance interval in the matched DCR curve correspond to the real-time impedance of the rechargeable battery, to obtain the impedance interval corresponding to the real-time impedance of the rechargeable battery. The terminal may search a DCR curve corresponding to each parameter of the battery information of the rechargeable battery, and obtain DCR curves corresponding to all battery information of the rechargeable battery, and the terminal may evaluate the DCR curves corresponding to all battery information, and determine a most suitable DCR curve for the rechargeable battery according to the evaluation result. Alternatively, the terminal may search a DCR curve group corresponding to a parameter of the battery information of the rechargeable battery, and then search DCR curves in the DCR curve group corresponding to other parameters of the battery information of the rechargeable battery, to obtain the impedance interval corresponding to the real-time impedance of the rechargeable battery.

The DCR curve includes a high-impedance interval and a low-impedance interval. The high-impedance interval and the low-impedance interval may be determined according to parameters of the DCR curve, such as the maximum impedance value, the average impedance value, a curve change trend, a rising amplitude, and a falling amplitude. The specific determination process will be described in detail hereinafter.

In step S103, the current charging strategy for the rechargeable battery is determined according to the impedance interval corresponding to the real-time impedance, the rechargeable battery is charged by using the current charging strategy. Determining the current charging strategy for the rechargeable battery according to the impedance interval corresponding to the real-time impedance includes in response to the real-time impedance of the rechargeable battery corresponding to the high-impedance interval, determining the current charging strategy to be a first charging strategy having a charging rate ranging from −0.2C to 0.2C, and in response to the real-time impedance of the rechargeable battery corresponding to the low-impedance interval, determining the current charging strategy to be a second charging strategy having a charging rate ranging from 0.5C to 5C.

In this embodiment, the terminal determines the corresponding current charging strategy according to the real-time impedance of the rechargeable battery. The real-time impedance of the rechargeable battery corresponding to the high-impedance interval indicates that an internal resistance of the rechargeable battery is relatively large, which may be caused by a high temperature of the battery, a battery aging, or some change inside the battery. In order to avoid an excessive pressure or a damage to the battery, the first charging strategy is selected as the current charging strategy, so as to charge the rechargeable battery by using the first charging strategy. The charging rate of the first charging strategy ranges from −0.2C to 0.2C, where C represents a rated capacity of the battery, and the charging rate represents that the battery is charged or discharged by how many times of the rated capacity. In the first charging strategy, the charging rate is relatively low, and the rechargeable battery is charged at a charging rate ranging from −0.2C to 0.2C, and the charging current is relatively small, which is beneficial to a long-term health of the battery. In addition, a negative charging rate means that the rechargeable battery is charged reversely. The real-time impedance of the rechargeable battery corresponds to the low-impedance interval, which indicates that the internal resistance of the battery is relatively small and the battery state is good, and in order to charge quickly, the current charging strategy is determined to be the second charging strategy, and the rechargeable battery is charged by using the second charging strategy. In the second charging strategy, the charging rate ranges from 0.5C to 5C, and the charging current corresponding to this range is relatively large, which can significantly shorten the charging duration. This method of adjusting the charging strategy according to the real-time impedance can more effectively manage the charging process of the battery, and improve the charging efficiency and safety of the battery.

In an embodiment of the present application, when the impedance interval corresponding to the real-time impedance of the rechargeable battery changes, the current charging strategy is adjusted in real time, and the rechargeable battery is charged with the current charging strategy adjusted in real time.

In this embodiment, during the charging process of the rechargeable battery, the terminal detects the real-time impedance of the rechargeable battery in real time, determines the impedance interval corresponding to the real-time impedance of the rechargeable battery, and adjusts the current charging strategy if the impedance interval corresponding to the real-time impedance of the rechargeable battery changes. When the impedance interval corresponding to the rechargeable battery changes from a high-impedance interval to a low-impedance interval, it indicates that the internal resistance of the rechargeable battery has decreased, and immediately the current charging strategy is switched from the first charging strategy (by which charging is carried out at a low charging rate) to the second charging strategy (by which charging is carried out at a high charging rate), so as to speed up the charging speed. When the impedance interval corresponding to the rechargeable battery changes from a low-impedance interval to a high-impedance interval, the internal resistance of the rechargeable battery increases, and at this instant, the current charging strategy is switched from the second charging strategy (by which charging is carried out at a high charging rate) to the first charging strategy (by which charging is carried out at a low charging rate), so as to reduce potential damages to the rechargeable battery.

In the above solutions, the impedance interval corresponding to the rechargeable battery in the DCR curve is determined based on the real-time impedance of the rechargeable battery, and the current charging strategy for the rechargeable battery is determined according to the impedance interval corresponding to the rechargeable battery, and the current charging strategy for the rechargeable battery is adjusted in real time according to the change of the impedance interval corresponding to the rechargeable battery. When the rechargeable battery is in the low-impedance interval, the second charging strategy is adopted to charge at a high charging rate, so that the rechargeable battery can be quickly charged and the charging duration can be shortened. When the rechargeable battery is in the high-impedance interval, the first charging strategy is adopted to charge at a low charging rate, so that the real-time impedance of the rechargeable battery can be quickly reduced to be within the low-impedance interval, which is conducive to prolonging the charging duration of the rechargeable battery charged by using the second charging strategy, prolonging the charging duration of the rechargeable battery charged at a high charging rate, improving the charging efficiency, and shortening the charging duration, so that the rechargeable battery can be quickly charged. Meanwhile, when the rechargeable battery is in the high-impedance interval, the rechargeable battery is charged at a low charging rate, thereby avoiding the risk of the lithium deposition or the excessive temperature rise in the battery caused when the battery is continuously charged at a high rate, ensuring that the rechargeable battery maintains a good charging state during the charging process, and ensuring that the rechargeable battery in different states can be safely and efficiently charged, and thus prolonging the service life of the battery and improving the charging efficiency of battery.

In an embodiment, determining the impedance interval in the DCR curve corresponding to the real-time impedance includes: obtaining the maximum impedance value of the DCR curve, determining the impedance interval in the DCR curve corresponding to the real-time impedance according to the maximum impedance value and the real-time impedance. When the real-time impedance is greater than 60% of the maximum impedance value, the real-time impedance belongs to the high-impedance interval, and when the real-time impedance is less than 60% of the maximum impedance value, the real-time impedance belongs to the low-impedance interval. When the real-time impedance is equal to 60% of the maximum impedance value, the real-time impedance belongs to the high-impedance interval or the low-impedance interval.

In this embodiment, the impedance interval of the DCR curve is defined according to the maximum impedance value of the DCR curve. If the impedance value is more than 60% of the maximum impedance value, the impedance value belongs to the high-impedance interval, and if the impedance value is less than 60% of the maximum impedance value, the impedance value belongs to the low-impedance interval. For example, if the maximum impedance value of the DCR curve is 100Ω and the real-time impedance of the rechargeable battery is 70Ω, the real-time impedance belongs to the high-impedance interval, and the first charging strategy is used for charging at a low charging rate. If the real-time impedance of the rechargeable battery is 50Ω, the real-time impedance belongs to the low-impedance interval, and the second charging strategy is used for charging at a high charging rate.

In another embodiment, the impedance interval of the DCR curve is defined according to an average impedance value of the DCR curve, and an impedance value greater than the average impedance value belongs to the high-impedance interval, and an impedance value less than the average impedance value belongs to the low-impedance interval. An impedance value equal to the average impedance value belongs to the high-impedance interval or the low-impedance interval.

In an embodiment, the impedance intervals of the DCR curve may also be defined according to a curve change trend, a rising amplitude, and a falling amplitude of the DCR curve.

In an embodiment, determining the DCR curve of the rechargeable battery includes step S101-1 to step S101-3.

In step S101-1, a current number of charge cycles of the rechargeable battery is obtained. The terminal may obtain the current number of charge cycles of the rechargeable battery through a battery management system (BMS) or through any other battery monitoring device. The charging impedance of the battery changes with the increase of the number of charge and discharge cycles. Obtaining the current number of charge cycles of the rechargeable battery makes it convenient to determine the DCR curve of the rechargeable battery according to the current number of charge cycles of the rechargeable battery and select a suitable charging strategy for charging, thereby improving the charging efficiency.

In step S101-2, a mapping relationship between the numbers of charge cycles and the DCR curves is obtained. The mapping relationship between the number of charge cycles and the DCR curve includes the DCR curves of the battery under different numbers of charge cycles, and the mapping relationship between the numbers of charge cycles and the DCR curves may be obtained based on experimental data or empirical formulas, and the mapping relationship between the numbers of charge cycles and the DCR curves is stored in a mapping relationship table or in a database.

In step S101-3, the DCR curve matching the current number of charge cycles of the rechargeable battery is obtained based on the current number of charge cycles and the mapping relationship between the numbers of charge cycles and the DCR curves. The terminal queries the mapping relationship table or the database to obtain the DCR curve matching the current number of charge cycles of the rechargeable battery.

In an embodiment, the mapping relationship between the numbers of charge cycles and the DCR curves is constructed by the following step S201 and step S202.

In step S201, DCR curves of a reference battery going through different numbers of charge cycles are obtained, where each of the DCR curves of the reference battery includes a corresponding relationship between states of charge (SOCs) and impedance values of the reference battery when the reference battery is charged from an empty state to a fully charged state.

In this embodiment, when the reference battery is charged for a different number of charge cycles, the terminal obtains the corresponding relationship between the SOCs and the impedance values of the reference battery during the process of charging the reference battery from an empty state (i.e., a fully discharged state) to a fully charged state, and establishes the DCR curves of the reference battery going through different numbers of charge cycles. The specific process of obtaining the DCR curves of the reference battery going through different numbers of charge cycles will be described in detail herein after.

In this embodiment, the reference battery is a battery identical with the rechargeable battery, which means that the reference battery and the rechargeable battery have the same model or the same factory batch, and that the reference battery and the rechargeable battery have the same cathode material and the same capacity, etc.

In step S202, a mapping relationship between the numbers of charge cycles and the DCR curves is constructed according to the DCR curves of the reference battery going through different numbers of charge cycles.

In this embodiment, the terminal constructs the mapping relationship between the numbers of charge cycles and the DCR curves according to the DCR curves of the reference battery going through different numbers of charge cycles, and the specific process of constructing the mapping relationship between the numbers of charge cycles and the DCR curves will be described in detail hereinafter.

The mapping relationship between the numbers of charge cycles and the DCR curves may be implemented by using charts, data, models, and formulas, and the terminal stores the mapping relationship between the numbers of charge cycles and the DCR curves in the mapping relationship table or in the database. After executing the step of constructing the mapping relationship between the numbers of charge cycles and the DCR curves, the terminal analyzes the mapping relationship between the numbers of charge cycles and the DCR curves to obtain a DCR curve matching the current number of charge cycles.

In an embodiment, obtaining the DCR curves of the reference battery going through different numbers of charge cycles includes step S2011 to step S2014.

In step S2011, a plurality of different preset numbers of charge cycles are determined, where each of the preset numbers of charge cycles is counted from an initial charging of the reference battery.

In this embodiment, the plurality of different preset numbers of charge cycles are determined to, for example, 100, 200, 300, 400, 500, 600, 700, 800, 900, and 1000.

In step S2012, an initial voltage curve of the reference battery during an initial charging is obtained.

In this embodiment, the reference battery leaving the factory is discharged to an empty state by using a standard discharge process. Then, the reference battery is charged at a charging rate of 0.02C, and stops charging for 60 minutes each time after charging for 30 minutes. Voltage values V_{X} and corresponding states of charge SOC_{X} are obtained until the reference battery is charged to a fully charged state. All the obtained voltage values and all the state of charges corresponding to all the voltage values are fitted to obtain the initial voltage curve of the reference battery for the first charge cycle. X=1,2,3, etc., and X is an integral greater than or equal to 1, and V_{X} denotes an X-th voltage value. The SOC of the empty state of the initial voltage curve of the reference battery for the first charge cycle is 0, and the SOC of the fully charged state thereof is 100.

In step S2013, the reference battery is discharged and charged cyclically, the reference battery is discharged to the empty state, and then the reference battery is charged from the empty state to the fully charged state by using a preset current, until the number of charge cycles of the reference battery reaches each of the plurality of different preset numbers of charge cycles, such that a first voltage curve of the reference battery at each of the plurality of different preset numbers of charge cycles is obtained, and a plurality of first voltage curves corresponding to the different preset numbers of charge cycles are obtained.

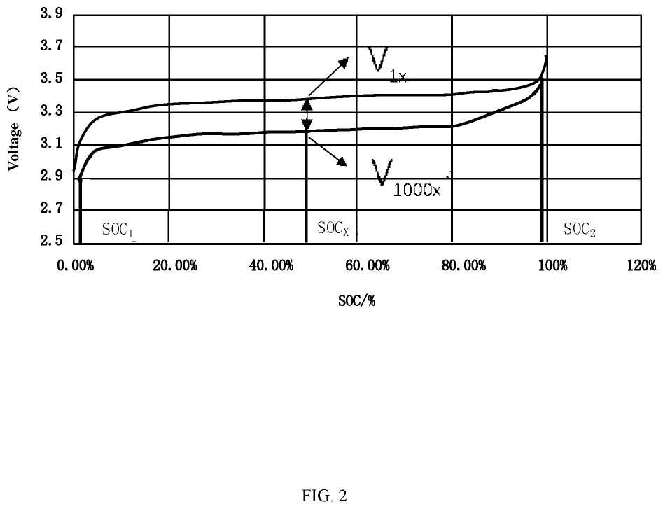

In this embodiment, referring to FIG. 2, after being initially charged to the fully charged state, the reference battery is discharged to the empty state by using a standard discharge process, and then the reference battery is charged to the fully charged state. This process is repeatedly performed.

In an embodiment, obtaining the first voltage curve of the reference battery at each of the plurality of different preset numbers of charge cycles includes: during each of the plurality of different preset numbers of charge cycles, charging the reference battery with a rated current, collecting a plurality of voltage values of the reference battery at an interval of a set time, and obtaining a plurality of SOCs corresponding to the plurality of voltage values of the reference battery; fitting the plurality of voltage values and the plurality of SOCs corresponding to the plurality of voltage values to obtain the first voltage curve of the reference battery at each of the plurality of different preset numbers of charge cycles.

Each time a set preset number of charge cycles is reached, for an example, when 100 or 200 of charge cycles is reached, the reference battery is charged with the rated current, and a plurality of voltage values of the reference battery are collected at an interval of a set time. For example, the set time may be defined as 0.1 s, 0.2 s, etc., and a plurality of SOCs corresponding to the plurality of voltage values of the reference battery at the preset number of charge cycles are obtained directly or calculated.

In an embodiment, the SOCs of the reference battery corresponding to the voltage values at the preset number of charge cycles are calculated according to the following equation:

$${SOC}_{X} = {SOC}_{1} + ( {SOC}_{2} - {SOC}_{1} ) \times \frac{{C}_{X}}{{C}_{1}} .$$

Referring to FIG. 2, SOC_{X} denotes any state of charge of the reference battery during a charging process at a preset number of charge cycles, SOC₁ denotes the state of charge of the reference battery in the empty state at the preset number of charge cycles, SOC₂ denotes the state of charge of the reference battery in the fully charged state at the corresponding preset number of charge cycles, C_{X} denotes a charge capacity of the reference battery during the charging process corresponding to the state of charge SOC_{X} at the corresponding preset number of charge cycles, and C₁ denotes the charge capacity in the initial voltage curve corresponding to the state of charge SOC_{X}. Specifically, C_{X} and C₁ may be directly determined during the whole charging process.

For example, at the 1000th charge cycle, C_{X} is 160 Ah, C₁ is 320 Ah, SOC₁ is 5%, and SOC₂ is 95%.

$${SOC}_{X} = 5 \% + ( 95 \% - 5 \% ) \times \frac{160 Ah}{320 Ah} = 50 \%$$

In this embodiment, the terminal calculates the SOCs of the reference battery corresponding to the voltage values at the preset number of charge cycles through the above equation instead of directly obtaining the SOCs of the reference battery, for the reason that after the reference battery has gone through multiple charge cycles, the actual SOC of the reference battery is lower than the SOC obtained by the terminal through the BMS or other battery monitoring device. In this way, the accuracy of the SOCs corresponding to the voltage values of the first voltage curve are ensured.

In step S2014, a plurality of impedance values corresponding to a plurality of SOCs in each first voltage curve are determined, and the correspondence relationship between the plurality of SOCs and the plurality of impedance values are fit to obtain a DCR curve corresponding to each of the plurality of different preset numbers of charge cycles to obtain a plurality of DCR curves corresponding to the different preset numbers of charge cycles.

The impedance value corresponding to the SOC of the first voltage curve is calculated according to the following equation:

$${Rn}_{{SOC}_{X}} ( {V}_{1 x} - {V}_{nX} ) / I .$$

Where, n denotes the preset number of charge cycles; SOC_{X} denotes any state of charge; Rn_{soc}_{_{X}} denotes the impedance value corresponding to the state of charge SOC_{X} at the preset number of charge cycles n; V_{1X} denotes the voltage value in the initial voltage curve corresponding to the state of charge SOC_{X}; V_{nX} denotes the voltage value corresponding to the state of charge SOC_{X} at the preset number of charge cycles n; and I denotes a preset current.

Referring to FIG. 2, for example, Rn_{soc}_{ₛₒ}=(3.38 v−3.18 v)×120 Ah=242.

In this embodiment, the terminal calculates the plurality of impedance values Rn_{soc}_{_{X}} corresponding to the plurality of states of charge SOC_{X} in the first voltage curve corresponding to a preset number of charge cycles, and the corresponding relationship between the multiple impedance values Rn_{soc}_{_{X}} and the multiple states of charge SOC_{X} is fitted to obtain the DCR curve corresponding to the preset number of charge cycles, and the above process is repeatedly performed to obtain the plurality of DCR curves corresponding to different preset numbers of charge cycles. The corresponding relationship between the states of charge SOC_{X} and the impedance values Rn_{soc}_{_{X}} may be fitted by a linear regression, a polynomial fitting, or a nonlinear fitting, etc.

In an embodiment, determining the DCR curve of the rechargeable battery includes step S101-4 to step S101-6.

In step S101-4, the cathode material of the rechargeable battery is determined.

In this embodiment, the terminal may obtain the cathode material of the rechargeable battery through the BMS or other battery monitoring device, such as lithium iron phosphate, lithium iron manganese phosphate, ternary lithium, etc. The DCR curves of different cathode materials vary greatly, which affects the charging process of the rechargeable battery.

In step S101-5, a mapping relationship between cathode materials and DCR curves are obtained.

In this embodiment, the mapping relationship between the cathode materials and the DCR curves includes the DCR curves of batteries having different cathode materials. The mapping relationship between the cathode materials and the DCR curves may be obtained through experimental data or empirical formulas. The mapping relationship between the cathode materials and the DCR curves is stored in the mapping relationship table or in the database.

In step S101-6, the DCR curve matching the rechargeable battery is obtained based on the cathode material of the rechargeable battery and the mapping relationship between the cathode materials and the DCR curves.

In this embodiment, the terminal queries the mapping relationship table or the database to obtain the DCR curve matching the cathode material of the rechargeable battery.

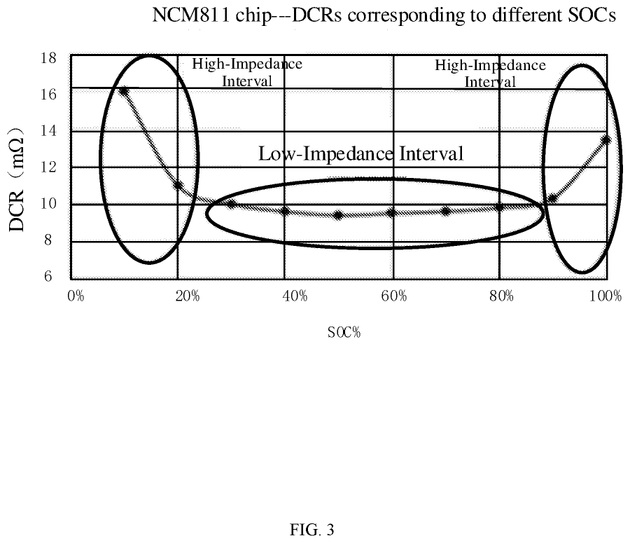

In an exemplary embodiment, referring to FIG. 3, the cathode material of the rechargeable battery obtained by the terminal is ternary lithium, and the terminals obtains the mapping relationship between the ternary lithium and the DCR curve, and obtains the DCR curve of the ternary lithium. The maximum impedance value of the DCR curve of the ternary lithium is 16Ω, and a range from SOC₀ to SOC₂₅ of the DCR curve of the ternary lithium corresponds to a high-impedance interval, a range from SOC₂₅ to SOC₈ s of the DCR curve of the ternary lithium corresponds to a low-impedance interval, and a range from SOC₈₅ to SOC₁₀₀ of the DCR curve of the ternary lithium corresponds to a high-impedance interval. SOCₘ denotes a state of charge being m, for example, SOC₈₅ denotes a state of charge being 85.

If the real-time impedance of the rechargeable battery belongs to the high-impedance interval, then the rechargeable battery is charged by using the first charging strategy, and the charging rate ranges from −0.2C to 0.2C, thus the charging current is relatively small, thereby reducing the real-time impedance of the rechargeable battery. If the real-time impedance of the rechargeable battery belongs to the low-impedance interval, then the rechargeable battery is charged by using the second charging strategy, and the charging rate ranges from 0.5C to 5C, thus the charging current is relatively large, thereby significantly shortening the charging duration.

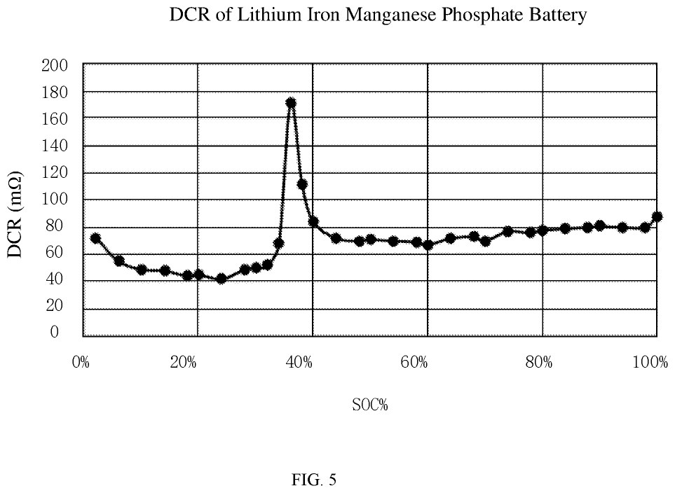

In an exemplary embodiment, referring to FIG. 5, the cathode material of the rechargeable battery obtained by the terminal is lithium iron manganese phosphate, and the terminal obtains a mapping relationship between the lithium iron manganese phosphate and the DCR curve, and obtains the DCR curve of the lithium iron manganese phosphate. The maximum impedance value of the DCR curve of the lithium iron manganese phosphate is 150Ω, and a range from SOC₀ to SOC₃₅ of the DCR curve of the lithium iron manganese phosphate corresponds to a low-impedance interval, a rang from SOC₃₅ to SOC₄₀ of the DCR curve of the lithium iron manganese phosphate corresponds to a high-impedance interval, and a range from SOC₄₀ to SOC₁₀₀ of the DCR curve of the lithium iron manganese phosphate corresponds to a low-impedance interval. If the real-time impedance of the rechargeable battery belongs to the high-impedance interval, then the rechargeable battery is charged by using the first charging strategy, thereby reducing the real-time impedance of the rechargeable battery. If the real-time impedance of the rechargeable battery belongs to the low-impedance interval, then the rechargeable battery is charged by using the second charging strategy.

In an embodiment, obtaining the real-time impedance of the charging battery includes step S1021 and step S1022.

In step S1021, a real-time charging voltage and a real-time SOC of the rechargeable battery are obtained in real time. Sensors are arranged on the cathode and anode of the rechargeable battery to detect the positive and negative electrode voltages and configured to measure the charging voltage of the rechargeable battery in real time. The terminal reads the real-time charging voltage of the rechargeable battery detected by the sensors. The terminal monitors charging parameters of the rechargeable battery through the BMS, and the charging parameters include, but are not limited to, a capacity of the rechargeable battery, a charged capacity of the rechargeable battery, a charging current, etc. The terminal calculates a real-time SOC of the rechargeable battery, and the terminal directly obtains or calculates the real-time SOC of the rechargeable battery in the same manner as in step S2013, and specifically calculates the real-time SOC of the rechargeable battery by using the following equation.

$${SOC}_{real} = {SOC}_{1} + ( {SOC}_{2} - {SOC}_{1} ) \times \frac{{C}_{real}}{{C}_{1}} ,$$

Where, SOCᵣₑₐₗ denotes the real-time state of charge of the reference battery, SOC, denotes the state of charge of the reference battery in the empty state at the current charge cycle, SOC₂ denotes the state of charge of the reference battery in the fully charged state at the current charge cycle, Cᵣₑₐₗ denotes a real-time charge capacity of the reference battery corresponding to the state of charge SOCᵣₑₐₗ at the current charge cycle, and C₁ denotes the charge capacity in the initial voltage curve corresponding to the real-time state of charge SOC_{X}. Specifically, C₁ and Cᵣₑₐₗ may be obtained directly.

In step S1022, the real-time impedance is obtained based on the real-time charging voltage and the real-time state of charge.

In this embodiment, the real-time impedance of the rechargeable battery is calculated by using the following equation.

$${R}_{{SOC}_{real}} ( {V}_{1} - {V}_{real} ) / I ,$$

Where SOCᵣₑₐₗ denotes the real-time state of charge of the rechargeable battery; R_{soc}_{ᵣₑₐₗ} denotes the impedance value corresponding to the SOCᵣₑₐₗ; V₁ denotes the voltage value in the initial voltage curve corresponding to the SOCᵣₑₐₗ; Vᵣₑₐₗ denotes the real-time voltage value of the rechargeable battery; and I is a preset current.

In an embodiment, the real-time impedance of the rechargeable battery may be obtained by the following implementation. Firstly, the cathode material of the rechargeable battery is determined, and the mapping relationship between the cathode materials and the DCR curves is obtained, and the DCR curve group matching the rechargeable battery is obtained based on the cathode material of the rechargeable battery and the mapping relationship between the cathode material and the DCR curve, and the DCR curve group includes DCR curves corresponding to multiple number of charge cycles. Then, the current number of charge cycles of the rechargeable battery is obtained, and the mapping relationship between the numbers of charge cycles and the DCR curves is obtained, and the DCR curve group corresponding to the rechargeable battery is queried, and the DCR curve matching the current number of charge cycles of the rechargeable battery is obtained based on the current number of charge cycles and the mapping relationship between the numbers of charge cycles and the DCR curves.

In this embodiment, the cathode material of the battery is determined firstly, and a corresponding DCR curve group is found based on the known mapping relationship. Then the number of charge cycles of the battery is determined, and the DCR curve group is queried to find a corresponding DCR curve, which is beneficial to battery management, battery health monitoring and optimization of charging strategies. By knowing the charging impedance of the battery, the charging process can be better controlled to avoid harmful situations such as overcharging and over-discharging, thereby prolonging the service life of the battery.

In an embodiment, during the entire charging process of the rechargeable battery, the terminal also continuously monitors the safety status of the battery, including parameters such as a temperature, a voltage, and a current, and immediately stops charging if any abnormality or potential safety risk is detected.

In an embodiment, the first charging strategy is implemented by alternately executing a first charging stage and a first depolarizing stage. The first charging strategy includes a charging rate and a charging duration of the first charging stage, and a depolarizing rate and a depolarizing duration of the first depolarizing stage. The charging duration of the first charging stage is determined according to a change trend of the DCR curve. When the DCR curve changes with a rising trend, the charging duration of the first charging stage decreases. When the DCR curve changes with a declining trend, the charging duration of the first charging stage increases. The depolarizing duration of the first depolarizing stage is determined according to the change trend of the DCR curve. When the DCR curve changes with a rising trend, the depolarizing duration of the first depolarizing stage increases. When the DCR curve changes with a declining trend, the depolarizing duration of the first depolarizing stage decreases. In this embodiment, the charging duration of each first charging stage ranges from 1 second to 600 seconds, and the depolarizing duration of the first depolarizing stage ranges from 1 second to 60 seconds.

The present embodiment is described by taking the cathode material of the rechargeable battery being ternary lithium as an example. Referring to FIG. 3, when the rechargeable battery corresponds to an interval from SOC₀ to SOC₂₅ of the DCR curve, the change trend of the DCR curve in the interval from SOC₀ to SOC₂₅ is a continuous decline, and the rechargeable battery is charged by using the first charging strategy, and the first charging stage and the first depolarizing stage are executed alternately. As the charging progresses, the charging duration of the first charging stage gradually increases, and the depolarizing duration of the first depolarizing stage gradually decreases. The declining trend of the change in the DCR curve indicates that the impedance value is reduced, the polarization effect of the battery is reduced, and shortening the depolarizing duration enables the real-time impedance of the rechargeable battery to be reduced to belong to the low-impedance interval more quickly.

When the rechargeable battery corresponds to an interval from SOC₈₅ to SOC₁₀₀ of the DCR curve, the DCR curve changes with a rising trend, and the rechargeable battery is charged by using the first charging strategy. As the charging progresses, the charging duration of the first charging stage gradually decreases, and the depolarizing duration of the first depolarizing stage gradually decreases. The depolarizing processing is strengthened for the high-impedance interval to eliminate a polarization phenomenon and accumulated charges.

In some embodiments, the charging rate of the first charging stage is also determined according to the change trend of the DCR curve. When the DCR curve changes with a rising trend, the charging rate of the first charging stage decreases. When the DCR curve changes with a declining trend, the charging rate of the first charging stage increases. The charging rate of the first charging stage ranges from 0C to 0.2C.

In some embodiments, the depolarizing rate of the first depolarizing stage is also determined according to the change trend of the DCR curve. When the DCR curve changes with a rising trend, the depolarizing rate of the first depolarizing stage decreases. When the DCR curve changes with a declining trend, the depolarizing rate of the first depolarizing stage increases. The depolarizing rate of the first depolarizing stage ranges from −0.2C to 0C.

In an embodiment, the second charging strategy is implemented by alternately executing a second charging stage and a second depolarizing stage. The second charging strategy includes a charging rate and a charging duration of the second charging stage, and a depolarizing rate and a depolarizing duration of the second depolarizing stage. The charging duration of the second charging stage is determined according to a change trend of the DCR curve. When the DCR curve changes with a rising trend, the charging duration of the second charging stage decreases. When the DCR curve changes with a declining trend, the charging duration of the second charging stage increases. The depolarizing duration of the second depolarizing stage is determined according to the change trend of the DCR curve. When the DCR curve changes with a rising trend, the depolarizing duration of the second depolarizing stage increases. When the DCR curve changes with a declining trend, the depolarizing duration of the second depolarizing stage decreases. In this embodiment, the charging duration of each second charging stage ranges from 1 second to 600 seconds, and the depolarizing duration of the second depolarizing stage ranges from 1 second to 60 seconds.

In some embodiments, the charging rate of the second charging stage is also determined according to the change trend of the DCR curve. When the DCR curve changes with a rise trend, the charging rate of the second charging stage decreases. When the DCR curve changes with a declining trend, the charging rate of the second charging stage increases. The charging rate of the second charging stage ranges from 2.5C to 5C.

In some embodiments, the depolarizing rate of the second depolarizing stage is also determined according to the change trend of the DCR curve. When the DCR curve changes with a rising trend, the depolarizing rate of the second depolarizing stage decreases, and when the DCR curve changes with a declining trend, the depolarizing rate of the second depolarizing stage increases. The depolarizing rate of the second depolarizing stage ranges from −0.2 to 2C.

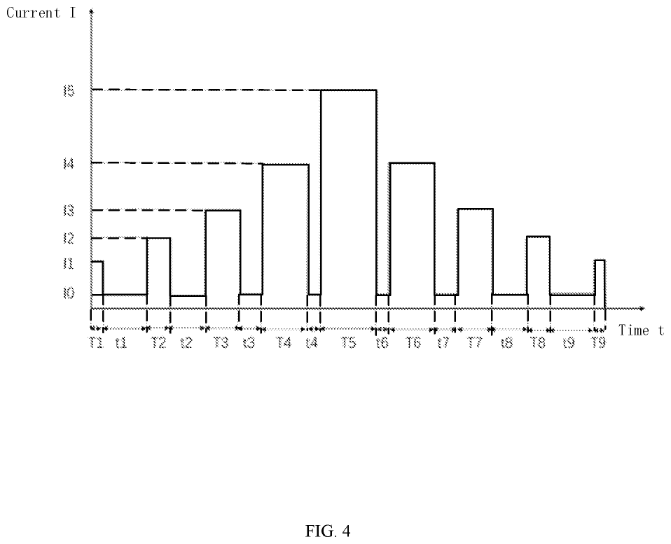

In an exemplary embodiment, the cathode material of the rechargeable battery is ternary lithium. FIG. 4 is a schematic view showing a second charging strategy for a low-impedance interval. As shown in FIG. 4, I1 to I5 denote the charging currents in the second charging stage, and the current values I1 to I5 correspond to the charging rate ranging from 0.5C to 5C, and I0 is a depolarizing current, and I0 corresponds to a charging rate of 0.2C. T1 to T9 denote the charging durations in the second charging stage, and T is between 1 second and 600 seconds. Moreover, t1 to t4, and t6 to t9 denote the depolarizing durations in the second depolarizing stage, and t is between 1 second and 60 seconds.

As shown in FIG. 3 and FIG. 4, the real-time impedance of the rechargeable battery belongs to the low-impedance interval. As the charging progresses, the DCR curve changes with a declining trend, the charging durations T1 to T5 of the second charging stage gradually increase, and the charging rate of the second charging stage continuously increases, the charging currents corresponding to the charging durations T1 to T5 of the second charging stage gradually increase from I1 to I5. The depolarizing durations t1 to t4 of the second depolarizing stage gradually decrease. That is, in the low-impedance interval, as the charging progresses, the DCR curve changes with a declining trend, the charging duration of the second charging stage is prolonged and the charging rate of the second charging stage is increased, and the depolarizing duration of the second depolarizing stage is reduced, thereby improving the charging efficiency of the battery, shortening the time to fully charge the battery, achieving a fast charging, and improving the charging efficiency.

As the charging progresses, the DCR curve changes from a declining trend to a rising trend, and the second charging strategy is adopted to continue charging the rechargeable battery. The charging durations T5 to T9 of the second charging stage gradually decrease, the charging currents corresponding to the charging durations T5 to T9 of the second charging stage gradually decrease from I5 to I1, and the depolarizing durations t6 to t9 of the second depolarizing stage gradually increase. In a middle and late stage of charging, due to slight changes in the internal structure of the battery (such as a change in electrolyte concentration, an increase in battery temperature, etc.), the impedance of the battery gradually increases, thus resulting in a slow charging speed. In this embodiment, the charging duration of the second charging stage is shortened, the charging rate of the second charging stage is reduced, and the depolarizing duration of the second depolarizing stage is increased, thereby more effectively removing polarization and improving the available capacity and charging efficiency of the battery.

A battery polarization means that, during the charge and discharge process of the battery, due to the incomplete reversibility of the electrode reaction, the ohmic resistance of the electrolyte solution, and the concentration polarization of the electrode surface, a potential difference will be generated inside the battery, that is, a polarization phenomenon occurs. The polarization phenomenon will reduce the discharge voltage and charging efficiency of the battery.

In an embodiment, the first charging strategy is implemented by alternately executing the first charging stage and the first depolarizing stage, and the second charging strategy is implemented by alternately executing the second charging stage and the second depolarizing stage. By configuring the depolarizing stages, the polarization phenomenon is eliminated or alleviated, and the performance and service life of the rechargeable battery are optimized, which has beneficial effects of suppressing an increase in the impedance of the rechargeable battery, prolonging the charging duration of the rechargeable battery corresponding to the low-impedance interval, prolonging the charging duration of the rechargeable battery charged by using the second charging strategy at a high charging rate, and shortening the time required to charge the battery to the fully charged state.

It should be understood that, although various steps in the flowcharts of various embodiments above are shown in sequence according to the indication of the arrows, these steps are not necessarily executed in sequence according to the order indicated by the arrows. Unless there is a clear explanation in this disclosure, the execution of these steps is not strictly limited in an order, and these steps may be executed in other orders. Moreover, at least part of steps in the flowcharts of various embodiments above may include multiple steps or multiple stages, and these steps or stages are not necessarily executed at the same time, but may be executed at different time, and the execution order of these steps or stages is not necessarily to be carried out in sequence, but may be executed in turn or alternately with other steps or at least part of the steps or stages in other steps.

Based on the same inventive concept, the embodiment of the present application further provides a device for implementing the battery charging method above. The implementation solutions provided by the device for solving a problem is similar to the implementation solutions described in the above method, and for the specific description of one or more embodiments of the battery charging device described hereinafter, reference may be made to the description of the battery charging method above, which will not be repeatedly described hereinafter.

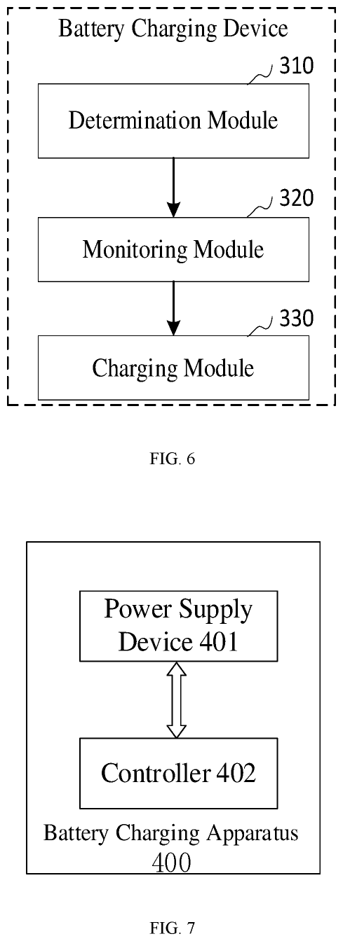

In an exemplary embodiment, as shown in FIG. 6, a battery charging device is provided, and includes: a determination module 310, a monitoring module 320, and a charging module 330.

The determination module 310 is configured to, in response to a charging instruction for a rechargeable battery, determine a DCR curve of the rechargeable battery.

The monitoring module 320 is configured to obtain a real-time impedance of the rechargeable battery, and determine an impedance interval in the DCR curve corresponding to the real-time impedance.

The charging module 330 is configured to determine the current charging strategy for the rechargeable battery according to the impedance interval corresponding to the real-time impedance, and charge the rechargeable battery by using the current charging strategy, and in response to the real-time impedance of the rechargeable battery corresponding to the high-impedance interval, determine the current charging strategy to be the first charging strategy having a charging rate ranging from −0.2C to 0.2C, and in response to the real-time impedance of the rechargeable battery corresponding to the low-impedance interval, determine the current charging strategy to be the second charging strategy having a charging rate ranging from 0.5C to 5C.

In an embodiment, the determination module 310 is specifically configured to obtain a current number of charge cycles of the rechargeable battery, obtain a mapping relationship between the numbers of charge cycles and the DCR curves, the DCR curve matching the current number of charge cycles of the rechargeable battery is obtained based on the current number of charge cycles and the mapping relationship between the numbers of charge cycles and the DCR curves.

In an embodiment, the determination module 310 is specifically configured to determine the cathode material of the rechargeable battery, obtain a mapping relationship between cathode materials and DCR curves, and obtain the DCR curve matching the rechargeable battery based on the cathode material of the rechargeable battery and the mapping relationship between the cathode materials and the DCR curves.

In an embodiment, the monitoring module 320 is specifically configured to obtain a real-time charging voltage and a real-time SOC of the rechargeable battery in real time, and obtain the real-time impedance based on the real-time charging voltage and the real-time SOC.

In an embodiment, the monitoring module 320 is further configured to obtain the maximum impedance value of the DCR curve, determine the impedance interval in the DCR curve corresponding to the real-time impedance according to the maximum impedance value and the real-time impedance, and when the real-time impedance is greater than 60% of the maximum impedance value, determine the real-time impedance to belong to the high-impedance interval, and when the real-time impedance is less than 60% of the maximum impedance value, determining the real-time impedance to belong to the low-impedance interval.

In an embodiment, the battery charging device further includes a mapping constructing module.

The mapping constructing module is configured to obtain DCR curves of a reference battery going through different numbers of charge cycles, where each of the DCR curves of the reference battery includes a corresponding relationship between states of charge (SOCs) and impedance values when the reference battery is charged from an empty state to a fully charged state, and configured to construct a mapping relationship between the numbers of charge cycles and the DCR curves according to the DCR curves of the reference battery going through different numbers of charge cycles.

The mapping constructing module is specifically configured to: determine a plurality of different preset numbers of charge cycles, where each of the preset numbers of charge cycles is counted from an initial charging of the reference battery; obtain an initial voltage curve of the reference battery during an initial charging; discharge and charge the reference battery cyclically, discharge the reference battery to the empty state, and then charge the reference battery from the empty state to the fully charged state by using a preset current, until the number of charge cycles of the reference battery reaches each of the plurality of different preset numbers of charge cycles, obtain a first voltage curve of the reference battery at each of the plurality of different preset numbers of charge cycles, and obtain a plurality of first voltage curves corresponding to the different preset numbers of charge cycles; and determine a plurality of impedance values corresponding to a plurality of SOCs in each first voltage curve, and fit the correspondence relationship between the plurality of SOCs and the plurality of impedance values to obtain a DCR curve corresponding to each of the plurality of different preset numbers of charge cycles, and obtain a plurality of DCR curves corresponding to the different preset numbers of charge cycles.

In an embodiment, the mapping constructing module is specifically configured to calculate the impedance value corresponding to the SOC of the first voltage curve according to the following equation:

$${Rn}_{{SOC}_{X}} ( {V}_{1 X} - {V}_{nX} ) / I$$

Where, n denotes the preset number of charge cycles; SOC_{X} denotes any state of charge; Rn_{soc}_{_{X}} denotes the impedance value corresponding to the state of charge SOC_{X} at the preset number of charge cycles n; V_{1X} denotes the voltage value in the initial voltage curve corresponding to the state of charge SOC_{X}; V_{nX} denotes the voltage value corresponding to the state of charge SOC_{X} at the preset number of charge cycles n; and I denotes a preset current.

In an embodiment, the mapping constructing module is further configured to construct a mapping relationship between the cathode materials and the DCR curves.

Each module in the battery charging device above may be implemented in whole or in part by software, hardware or a combination thereof. Each of the above-mentioned modules may be embedded in or independent of a processor of a controller in the form of hardware, or may be stored in a memory of the controller in the form of software, so that the processor can call and execute corresponding operations of each of the above modules.

In a third aspect, referring to FIG. 7, the present disclosure provides a battery charging apparatus 400. The battery charging apparatus 400 includes: a power supply device 401 and a controller 402. The power supply device 401 is configured to charge a rechargeable battery. The controller 402 includes at least one processor, and at least one memory communicatively connected to the at least one processor. The memory stores a computer program that can be executed by the at least one processor, and the computer program is executed by the at least one processor so that the at least one processor can execute the battery charging method in the above-mentioned embodiment. In an embodiment, the battery charging apparatus 400 further includes a battery management system (BMS) or any other battery monitoring device.

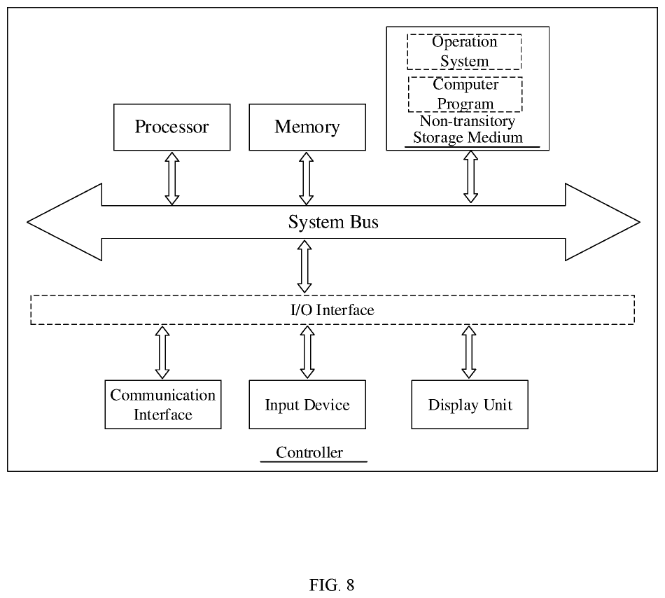

In an exemplary embodiment, the controller 402 may be a terminal, and an internal structure may be as shown in FIG. 8. The controller 402 includes a processor, a memory, an input/output interface, a communication interface, a display unit, and an input device. The processor, the memory, the input/output interface are connected to a system bus. The processor of the controller is configured to provide computing and control capabilities. The memory of the controller includes a non-transitory storage medium and an internal memory. The non-transitory storage medium stores an operating system and a computer program. The internal memory provides an environment for the operation of the operating system and the computer program in the non-transitory storage medium. The input/output interface of the controller is configured to exchange information between the processor and an external device. The communication interface of the controller is configured to communicate with an external terminal in a wired or wireless manner, and the wireless manner may be implemented through WIFI, a mobile cellular network, a near field communication (NFC), or other technologies. The computer program, when executed by the processor, executes a battery charging method. The display unit of the controller is configured to form a visually visible picture, and may be a display screen, a projection device or a virtual reality imaging device. The display screen may be a liquid crystal display screen or an electronic ink display screen. The input device of the controller may be a touch layer covered on the display screen, a key, a trackball or a touch pad arranged on the housing of the controller, or may be an external keyboard, an external touch pad or an external mouse, etc.

Those ordinary skilled in the art may understand that the structure shown in FIG. 8 is merely a block diagram of a partial structure related to the solutions of the present application, and is not intended to constitute a limitation on the controller to which the scheme of the present application is applied. A specific controller may include more or fewer components than those shown in the figure, or combine certain components, or have a different arrangement of components.

In a fourth aspect, the present disclosure provides a non-transitory computer-readable storage medium, having computer instructions stored thereon. The computer instructions, when executed, force a processor to perform the battery charging method of the first aspect.

In an embodiment, a computer program product is provided, and includes a computer program. The computer program, when executed by a processor, force the processor to perform the steps of any one of the methods in the first aspect.

It should be noted that user information (including but not limited to user device information, user personal information, etc.) and data (including but not limited to data used for analysis, stored data, displayed data, etc.) involved in this application are all information and data authorized by the user or fully authorized by all parties, and the collection, use and processing of relevant data must comply with relevant regulations.

Those ordinary skilled in the art may understand that all or part of the process in the method of the above embodiments may be implemented by instructing the relevant hardware through a computer program, and the computer program may be stored in a non-transitory computer-readable storage medium. The computer program, when executed, may include the processes of the embodiments of the methods above. Any reference to memory, database, or other medium used in the various embodiments provided in this application may include at least one of non-transitory and transitory memory. Non-transitory memory may include read-only memory (ROM), magnetic tape, floppy disk, flash memory, optical memory, high-density embedded non-transitory memory, resistance random access memory (ReRAM), magneto resistive random-access memory (MRAM), ferroelectric random-access memory (FRAM), phase change memory (PCM), or graphene memory, and the like. The transitory memory may include random access memory (RAM) or external cache memory. By way of illustration and not limitation, the RAM may be in various forms, such as static random-access memory (SRAM) or dynamic random-access memory (DRAM), etc. The databases involved in the embodiments provided in the present application may include at least one of a relational database and a non-relational database. The non-relational databases may include, but are not limited to, a blockchain-based distributed database, and the like. The processor involved in the embodiments provided in the present application may be, but are not limited to, a general-purpose processor, a central processing unit, a graphics processor, a digital signal processor, a programmable logic, a quantum-computing-based data processing logic, and the like.

The technical features of the embodiments above may be combined arbitrarily. To make the description concise, not all possible combinations of the technical features in the above embodiments are described. However, as long as there are no contradictions in the combinations of these technical features, all of the combinations should be considered to be within the scope of the specification.

The embodiments above only represent several implementation modes of the present application, and the description thereof is relatively specific and detailed, but it should not be construed as limiting the scope of the patent. It should be noted that for those ordinary skilled in the art, various modifications and improvements may be made without departing from the concept of the present application, and all these modifications and improvements are within the protection scope of the present application. Therefore, the scope of protection of the patent application should be subject to the appended claims.

What is claimed is:

1. A battery charging method, comprising:
determining a direct current resistance (DCR) curve of a rechargeable battery in response to a charging instruction for the rechargeable battery;
obtaining a real-time impedance of the rechargeable battery, and determining an impedance interval in the DCR curve corresponding to the real-time impedance; and
determining a current charging strategy for the rechargeable battery according to the impedance interval corresponding to the real-time impedance, and charging the rechargeable battery by using the current charging strategy;
wherein determining the current charging strategy for the rechargeable battery according to the impedance interval corresponding to the real-time impedance comprises:
determining the current charging strategy to be a first charging strategy having a charging rate ranging from −0.2C to 0.2C, in response to the real-time impedance of the rechargeable battery corresponding to a high-impedance interval; and
determining the current charging strategy to be a second charging strategy having a charging rate ranging from 0.5C to 5C, in response to the real-time impedance of the rechargeable battery corresponding to a low-impedance interval.

2. The battery charging method according to claim 1, wherein determining the impedance interval in the DCR curve corresponding to the real-time impedance comprises:
obtaining the maximum impedance value of the DCR curve; and
determining the impedance interval in the DCR curve corresponding to the real-time impedance according to the maximum impedance value and the real-time impedance.

3. The battery charging method according to claim 2, wherein determining the impedance interval in the DCR curve corresponding to the real-time impedance according to the maximum impedance value and the real-time impedance comprises:
determining the real-time impedance to belong to the high-impedance interval, in response to the real-time impedance being greater than 60% of the maximum impedance value;
determining the real-time impedance to belong to the low-impedance interval, in response to the real-time impedance being less than 60% of the maximum impedance value; and
determining the real-time impedance to belong to the high-impedance interval or the low-impedance interval, in response to the real-time impedance being equal to 60% of the maximum impedance value.

4. The battery charging method according to claim 1, wherein determining the DCR curve of the rechargeable battery comprises:
obtaining a current number of charge cycles of the rechargeable battery;
obtaining a mapping relationship between numbers of charge cycles and DCR curves; and
obtaining the DCR curve matching the current number of charge cycles of the rechargeable battery based on the current number of charge cycles and the mapping relationship between the numbers of charge cycles and the DCR curves.

5. The battery charging method according to claim 4, wherein obtaining the mapping relationship between the numbers of charge cycles and the DCR curves comprises:
obtaining DCR curves of a reference battery going through different numbers of charge cycles, each of the DCR curves of the reference battery comprising a corresponding relationship between states of charge (SOCs) and impedance values of the reference battery when the reference battery is charged from an empty state to a fully charged state; and
constructing the mapping relationship between the numbers of charge cycles and the DCR curves according to the DCR curves of the reference battery going through the different numbers of charge cycles.

6. The battery charging method according to claim 5, wherein obtaining the DCR curves of the reference battery going through the different numbers of charge cycles comprises:
determining a plurality of different preset numbers of charge cycles, each of the plurality of different preset numbers of charge cycles is counted from an initial charging of the reference battery;
obtaining an initial voltage curve of the reference battery during the initial charging;
discharging and charging the reference battery cyclically, discharging the reference battery to an empty state, and charging the reference battery from the empty state to a fully charged state by using a preset current, until the number of charge cycles of the reference battery reaches each of the plurality of different preset numbers of charge cycles, and obtaining a first voltage curve of the reference battery at each of the plurality of different preset numbers of charge cycles, and obtaining a plurality of first voltage curves corresponding to the different preset numbers of charge cycles; and
determining a plurality of impedance values corresponding to a plurality of SOCs in each of the plurality of first voltage curves, and fitting a correspondence relationship between the plurality of SOCs and the plurality of impedance values to obtain a DCR curve corresponding to each of the plurality of different preset numbers of charge cycles, and obtaining a plurality of DCR curves corresponding to the different preset numbers of charge cycles.

7. The battery charging method according to claim 6, wherein each of the plurality of impedance values corresponding to each of the plurality of SOCs of each of the plurality of first voltage curves is calculated according to an equation:
$${Rn}_{{SOC}_{X}} ( {V}_{1 x} - {V}_{nX} ) / I$$
wherein, n denotes a preset number of charge cycles; SOC_{X} denotes a state of charge; Rn_{soc}_{_{X}} denotes an impedance value corresponding to the state of charge SOC_{X} at the preset number of charge cycles n; V_{1X} denotes a voltage value in the initial voltage curve corresponding to the state of charge SOC_{X}; V_{nX} denotes a voltage value corresponding to the state of charge SOC_{X} at the preset number of charge cycles n; and I denotes a preset current.

8. The battery charging method according to claim 6, wherein obtaining the first voltage curve of the reference battery at each of the plurality of different preset numbers of charge cycles comprises:
during each of the plurality of different preset numbers of charge cycles, charging the reference battery with a rated current, and collecting a plurality of voltage values of the reference battery at an interval of a set time, and obtaining a plurality of SOCs corresponding to the plurality of voltage values of the reference battery; and
fitting the plurality of voltage values and the plurality of SOCs corresponding to the plurality of voltage values to obtain the first voltage curve of the reference battery at each of the plurality of different preset numbers of charge cycles.

9. The battery charging method according to claim 8, each of the plurality of SOCs corresponding to the plurality of voltage values of the reference battery is calculated according to an equation:
$${SOC}_{X} = {SOC}_{1} + ( {SOC}_{2} - {SOC}_{1} ) \times \frac{{C}_{X}}{{C}_{1}}$$
wherein SOC_{X} denotes a state of charge, SOC₁ denotes a state of charge of the reference battery in the empty state at a preset number of charge cycles, SOC₂ denotes a state of charge of the reference battery in the fully charged state at the preset number of charge cycles, C_{X} denotes a charge capacity of the reference battery during a charging process corresponding to the state of charge SOC_{X} at the preset number of charge cycles, and C₁ denotes a charge capacity in the initial voltage curve corresponding to the state of charge SOC_{X}.

10. The battery charging method according to claim 1, wherein determining the DCR curve of the rechargeable battery comprises:
determining a cathode material of the rechargeable battery;
obtaining a mapping relationship between cathode materials and DCR curves; and
obtaining the DCR curve matching the rechargeable battery based on the cathode material of the rechargeable battery and the mapping relationship between the cathode materials and the DCR curves.

11. The battery charging method according to claim 1, wherein obtaining the real-time impedance of the rechargeable battery comprises:
obtaining a real-time charging voltage and a real-time SOC of the rechargeable battery in real time; and
obtaining the real-time impedance based on the real-time charging voltage and the real-time state of charge.

12. The battery charging method according to claim 1, wherein the first charging strategy is implemented by alternately executing a first charging stage and a first depolarizing stage; and the first charging strategy comprises a charging rate and a charging duration of the first charging stage, and a depolarizing rate and a depolarizing duration of the first depolarizing stage;
the charging duration of the first charging stage is determined according to a change trend of the DCR curve, wherein when the DCR curve changes with a rising trend, the charging duration of the first charging stage decreases, and when the DCR curve changes with a declining trend, the charging duration of the first charging stage increases; and
the depolarizing duration of the first depolarizing stage is determined according to the change trend of the DCR curve, wherein when the DCR curve changes with a rising trend, the depolarizing duration of the first depolarizing stage increases, and when the DCR curve changes with a declining trend, the depolarizing duration of the first depolarizing stage decreases.

13. The battery charging method according to claim 12, wherein the charging rate of the first charging stage is determined according to the change trend of the DCR curve, wherein when the DCR curve changes with the rising trend, the charging rate of the first charging stage decreases, and when the DCR curve changes with the declining trend, the charging rate of the first charging stage increases; and the charging rate of the first charging stage ranges from 0C to 0.2C; and
the depolarizing rate of the first depolarizing stage is determined according to the change trend of the DCR curve, wherein when the DCR curve changes with the rising trend, the depolarizing rate of the first depolarizing stage decreases, and when the DCR curve changes with the declining trend, the depolarizing rate of the first depolarizing stage increases; and the depolarizing rate of the first depolarizing stage ranges from −0.2C to 0C.

14. The battery charging method according to claim 1, wherein the second charging strategy is implemented by alternately executing a second charging stage and a second depolarizing stage; and the second charging strategy comprises a charging rate and a charging duration of the second charging stage, and a depolarizing rate and a depolarizing duration of the second depolarizing stage;
the charging duration of the second charging stage is determined according to a change trend of the DCR curve, wherein when the DCR curve changes with a rising trend, the charging duration of the second charging stage decreases, and when the DCR curve changes with a declining trend, the charging duration of the second charging stage increases; and
the depolarizing duration of the second depolarizing stage is determined according to the change trend of the DCR curve, wherein when the DCR curve changes with a rising trend, the depolarizing duration of the second depolarizing stage increases, and when the DCR curve changes with a declining trend, the depolarizing duration of the second depolarizing stage decreases.

15. The battery charging method according to claim 14, wherein the charging rate of the second charging stage is determined according to the change trend of the DCR curve, wherein when the DCR curve changes with the rise trend, the charging rate of the second charging stage decreases, and when the DCR curve changes with the declining trend, the charging rate of the second charging stage increases; and the charging rate of the second charging stage ranges from 2.5C to 5C; and
the depolarizing rate of the second depolarizing stage is determined according to the change trend of the DCR curve; wherein when the DCR curve changes with the rising trend, the depolarizing rate of the second depolarizing stage decreases, and when the DCR curve changes with the declining trend, the depolarizing rate of the second depolarizing stage increases; and the depolarizing rate of the second depolarizing stage ranges from −0.2C to 2C.

16. The battery charging method according to claim 1, wherein determining the impedance interval in the DCR curve corresponding to the real-time impedance comprises:
obtaining an average impedance value of the DCR curve;
determining the impedance interval in the DCR curve corresponding to the real-time impedance as a high-impedance interval in response to the real time impedance is greater than the average impedance value;
determining the impedance interval in the DCR curve corresponding to the real-time impedance as a low-impedance interval in response to the real time impedance is less than the average impedance value; and
determining the impedance interval in the DCR curve corresponding to the real-time impedance as the high-impedance interval or the low-impedance interval in response to the real time impedance is equal to the average impedance value.

17. The battery charging method according to claim 6, wherein fitting the correspondence relationship between the plurality of SOCs and a plurality of impedance values comprises fitting the correspondence relationship between the plurality of SOCs and the plurality of impedance values by any one of a linear regression, a polynomial fitting, and a nonlinear fitting.

18. The battery charging method according to claim 8, wherein the set time is 0.1 s or 0.2 s.

19. The battery charging method according to claim 10, wherein obtaining the mapping relationship between the cathode materials and the DCR curves comprises obtaining the mapping relationship between the cathode materials and the DCR curves through experimental data or empirical formulas, wherein the mapping relationship between the cathode materials and the DCR curves is stored in a mapping relationship table or in a database.

20. A battery charging apparatus, comprising:
a power supply device configured to charge a rechargeable battery;
a controller comprising at least one processor and a memory communicatively connected to the at least one processor; wherein the memory has a computer program stored thereon, and the computer program is executable by the at least one processor, and the computer program, when executed by the at least one processor, forces the at least one processor to perform the battery charging method of claim 1.
